(19) United States
(12) Patent Application Publication
(10) Pub. No.: US 2026/0195353 A1
(43) Pub. Date: Jul. 9, 2026

(54) Response Generation with Feedback Lessons

(71) Applicant: Sierra Technologies, Inc., San Francisco, CA (US)

(72) Inventors: Clayton Woodward Bavor, JR., Atherton, CA (US); Noah Ryan Shinn, San Francisco, CA (US); Valjean Clark, San Francisco, CA (US); Manat Kaur, Menlo Park, CA (US)

(21) Appl. No.: 19/442,994

(22) Filed: Jan. 7, 2026

Related U.S. Application Data
(60) Provisional application No. 63/743,096, filed on Jan. 8, 2025.

(51) Int. Cl. G06F 16/3329

(52) U.S. Cl. CPC G06F 16/33295

(57) ABSTRACT

A system receives, via an agent, a user input in a conversation between the agent and a user. The system identifies, using the agent, a set of features associated with the user input in the conversation. The system identifies, from a database, a feedback lesson based on the set of features, where the feedback lesson comprises a coaching input having one or more of the set of features and a recommendation on generating a response to the coaching input. The system generates a prompt for input to a machine-learned language model, where the prompt specifies at least the user input, the identified feedback lesson, and a request to generate a response to the user input using the recommendation in the identified feedback lesson. The system provides the prompt to the machine-learned language model to generate the requested response.

### CROSS REFERENCE TO RELATED APPLICATION

This application claims the benefit of U.S. Provisional Application No. 63/743,096, filed January 8, 2025, which is incorporated by reference.

### TECHNICAL FIELD

The disclosure generally relates to the field of artificial intelligence, and more specifically relates to a declarative agent using machine learning models.

### BACKGROUND

Agents are software that coordinate sequences of interactions with AI (artificial intelligence), such as LLMs (large language models) and external software systems. Using AI significantly enhances the agents’ functionality, efficiency, and user experience by enabling more sophisticated, personalized, and context-aware interactions. AI enables the agents to learn and improve continuously based on user interactions. Through machine learning techniques, agents can identify patterns in user feedback, preferences, and behaviors, allowing them to enhance responses, refine intent recognition, and reduce errors over time. User feedback is crucial for improving the AI models because it provides direct insight into real user experiences, revealing both the strengths and weaknesses of the AI in handling queries. By collecting and analyzing user feedback, AI model can be retrained to be more accurately tailored to user needs, leading to improvements in performance, relevance, and user satisfaction.

However, frequent retraining of AI models comes with high computational demands, especially given the complexity of modern AI models. These models require substantial computational power to achieve accuracy, often relying on high-performance GPUs or TPUs (Tensor Processing Units) that enable the parallel processing needed for effective model updates. For even moderately complex models, retraining can span hours to days depending on the volume of data and the architecture’s complexity. Such high computational requirements pose logistical challenges, as teams need access to powerful hardware, which may not always be readily available or scalable in traditional IT infrastructures.

### SUMMARY

Systems and methods are disclosed herein that generates a response to user input using a feedback lesson. In this disclosure, a method is provided to enhance an AI agent’s performance by leveraging feedback from previous interactions, without needing to retrain or update the entire model. Instead, each piece of feedback is transformed into a “feedback lesson” that serves as contextual guidance when generating responses. The system may collect and package feedback from past conversations. Feedback from previous conversations is gathered and analyzed to create “feedback lessons,” which are structured guidelines or targeted adjustments based on areas of improvement identified in past interactions. User feedback may be evaluated by either a human reviewer or a language model, which extracts defining features such as tone, content, intent, etc. By categorizing these features, the system may later retrieve the most relevant feedback for similar queries in the future.

When a new user query is received, the system identifies any relevant feedback lessons by matching the features of the current query with previously stored feedback. For example, the most relevant feedback lesson may be embedded directly into the prompt for the language model, adding contextual guidance that aligns the response with past improvements. This allows the model to tailor its responses in real-time based on specific, targeted feedback without undergoing retraining.

With this dynamic prompting approach, the model’s static foundation is supplemented by situational adjustments. Each prompt benefits from retrieved feedback lessons, which guide the model toward responses that reflect desired qualities like accuracy, empathy, or user-friendly language. This method provides the flexibility to improve response quality continuously while keeping the model structure stable, making it both adaptive and efficient.

In one aspect, the disclosure provides a system that receives a user input in a conversation between the agent and the user. They system identifies a set of features associated with the user input in the conversation and a feedback lesson based on the set of features. The feedback lesson may include a coaching input having one or more of the set of features and a recommendation on generating a response to the coaching input. The system may generate a prompt for input to a machine-learned language model, and the prompt specifies at least the user input, the identified feedback lesson, and a request to generate a response to the user input using the recommendation in the identified feedback lesson. The system may provide the prompt to the machine-learned language model to generate the requested response and receive an output that includes the generated response to the user input.

### BRIEF DESCRIPTION OF DRAWINGS

The disclosed embodiments have other advantages and features which will be more readily apparent from the detailed description, the appended claims, and the accompanying figures(or drawings). A brief introduction of the figures is below.

FIG. 1 illustrates one embodiment of a system environment for implementing a declarative agent service.

FIG. 2 illustrates one embodiment of modules of the declarative agent service.

FIG. 3 is a flowchart for a method of generating a response to user input using a feedback lesson.

FIG. 4 is a block diagram illustrating components of an example machine able to read instructions from a machine-readable medium and execute them in a processor (or controller).

### DETAILED DESCRIPTION

The Figures(FIGS.) and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to several embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

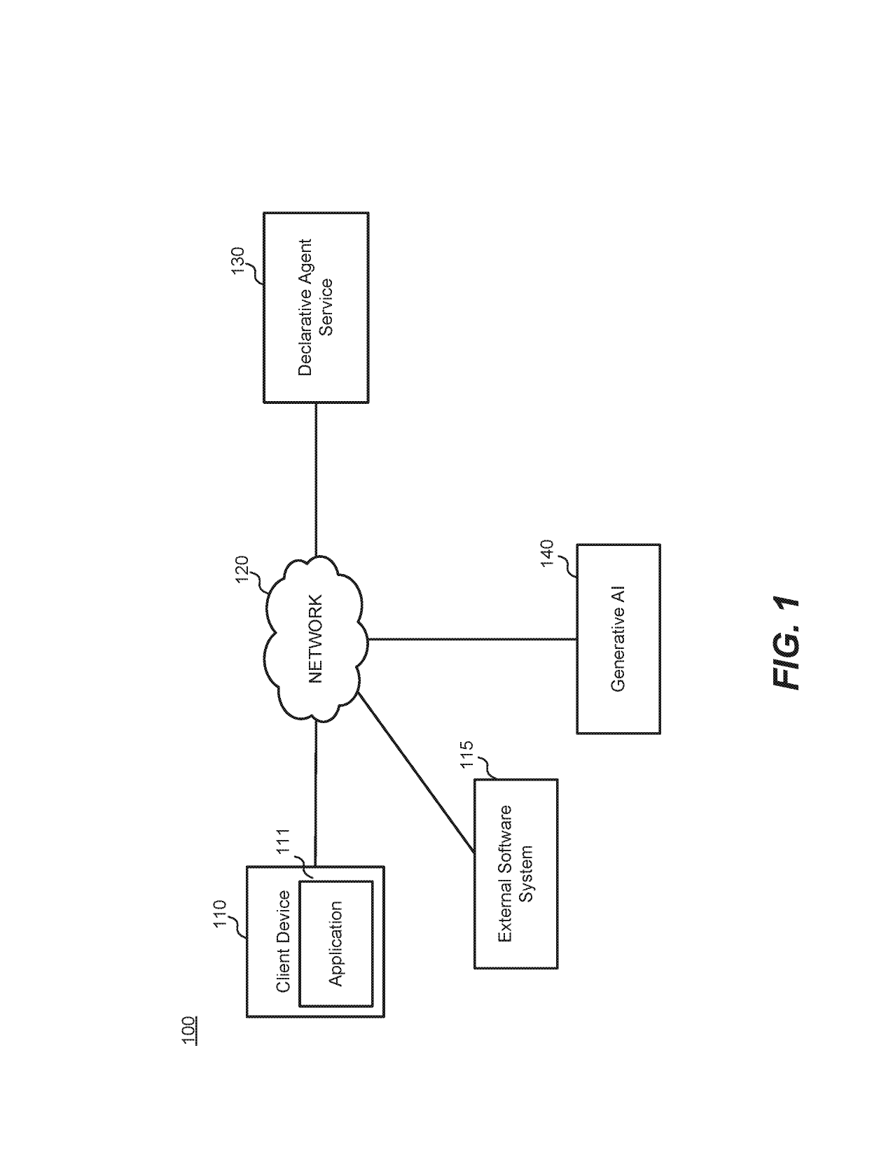

FIG. 1 illustrates one embodiment of a system environment for implementing a declarative agent service. As depicted in FIG. 1, declarative agent service environment 100 includes client device 110. While policy enforcement application 111 is only depicted with respect to one client device 110, this is for convenience only, and many number of client devices may be interacting with declarative agent service 130. Client device 110 may be any device operated by an end-user having a user interface, such as a smartphone, a laptop, a personal computer, a wearable (e.g., smart watch), a kiosk, or any other electronic device capable of interfacing between a user and declarative agent service 130.

Declarative agent service 130 may be accessed by client device 110 using application 111. Application 111 may be an application dedicated to activities of declarative agent service 130 (e.g., an installed software package downloaded from declarative agent service 130 or an external repository such as an app store or installed using other means such as a hard disk). Alternatively, or additionally, application 111 may be a browser through which declarative agent service 130’s functionality may be accessed (e.g., directly, or indirectly through an embedded portal in a website of third party company).

External software system 115 may be a software system of, e.g., a platform that utilizes declarative agent service 130. External software system 115 may require human intervention or may be utilized without a human in the loop, and may be configured to provide functionality, such as chatbot (interchangeably used with “chat automation system”) functionality to users of the platform. Client device 110 may be used by an entity controlling external software system 115 to communicate to declarative agent service 130 information sufficient to deploy guardrails on LLM outputs and/or may be used by end-users interacting with external software system 115 to resolve and otherwise chat through an issue.

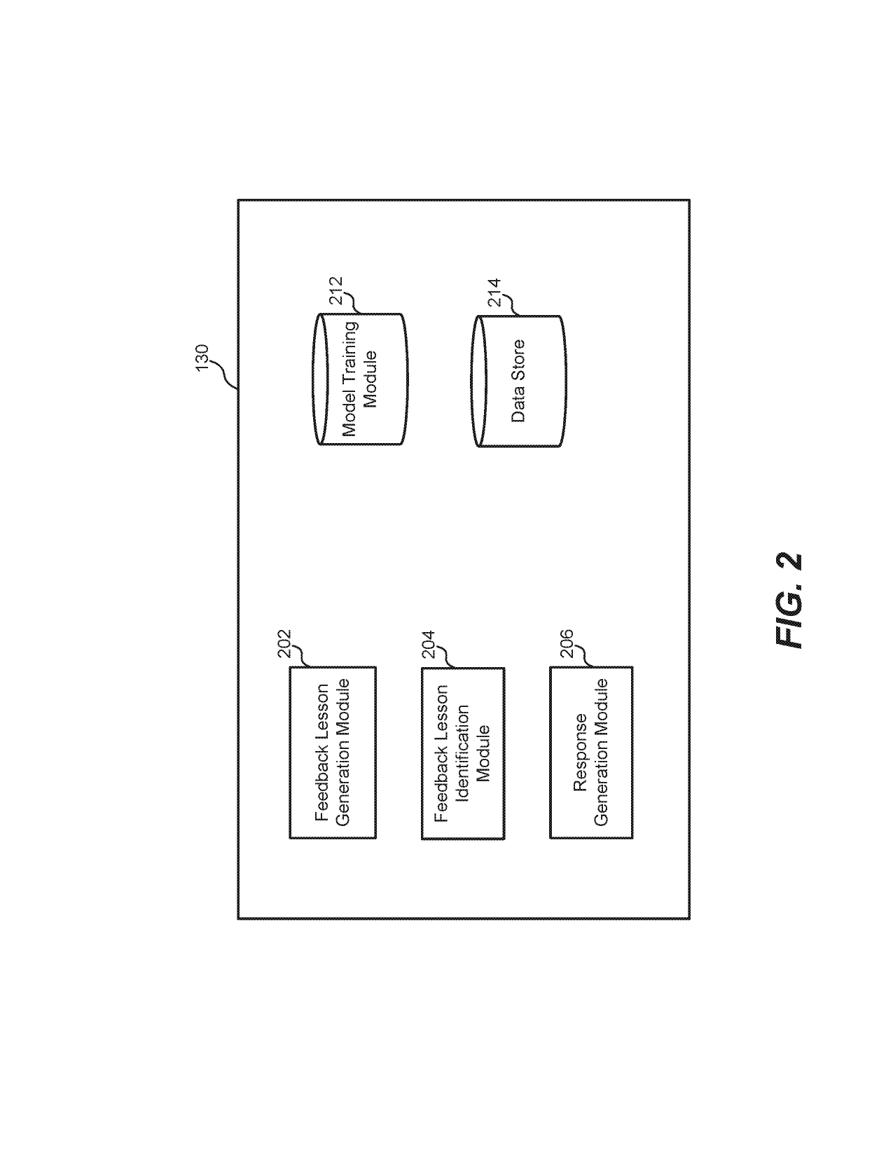

Declarative agent service 130 is used by client devices 110 and /or external software system 115 to provide a chat interface that addresses inquiries by users or by the platform of an external software system. Declarative agent service 130 is instantiated on one or more servers, accessible by way of network 120. Some or all functionality of declarative agent service 130 described herein may be distributed or fully performed by application 111 on a client device, or vice versa. Where reference is made herein to activity performed by application 111, it equally applies that declarative agent service 130 may perform that activity off of the client device, and vice versa. Declarative agent service 130 may be provided as a software development kit (SDK) to a client device or external software service to enable these entities to build the functionality of declarative agent service 130 on-premises. The SDK may export an API such that 3rd parties (e.g., client devices or external software services) can specify their agents. Agent code using the SDK API is then uploaded to declarative agent service 130, on which it can execute (and run as an agent). Further details about the operation of declarative agent service 130 are described below with reference to FIG. 2.

Generative AI 140 may be part of declarative agent service 130 or may be a third-party provider (e.g., OpenAI) that provides generative AI for processing natural language queries. Generative AI 140 may include one or many LLMs, the LLMs provided by any number of providers.

FIG. 2 illustrates one embodiment of modules of the policy enforcement service. As depicted in FIG. 2, the declarative agent service 130 includes feedback lesson generation module 202, a feedback lesson identification module 204, a response generation module 206, a model training module 212, and a data store 214. These modules and databases are merely illustrative; fewer or more modules and/or databases may be used to achieve the functionality disclosed herein.

The feedback lesson generation module 202 receives user feedback and generate feedback lessons based on the user feedback. A “feedback lesson” is a way to treat a piece of feedback as a specific learning example that the agent may use to improve its responses in similar future scenarios. Instead of simply collecting feedback passively, the feedback lesson generation module 202 may curate and contextualize the feedback instance to form a focused training session. For instance, if a user provides feedback saying, “The response was too vague,” a feedback lesson would provide the context of that conversation, specifying the user’s question, the response generated by the agent, and the type of improvement needed (e.g., more detailed answers). By structuring feedback in this way, the model used by the agent to generate responses may be updated to better handle similar future conversations.

The feedback lesson generation module 202 may obtain user feedback on the responses generated by agents, such as through ratings, buttons, and comments. For instance, the feedback lesson generation module 202 may receive user feedback via a rating system—like thumbs-up/thumbs-down buttons, a star rating (1 to 5 stars), or binary options (e.g., “helpful” or “not helpful”), etc., which allows users to quickly indicate whether the responses met their expectations. In some implementations, the feedback lesson generation module 202 may receive feedback with explicit content, for example, users may specify what went wrong if they weren’t fully satisfied with the response. In some implementations, surveys or follow-up feedback requests help capture overall satisfaction levels, providing feedback that reflects a longer-term experience rather than just an individual response.

The feedback lesson generation module 202 may use the received user feedback to generate feedback lessons. Each feedback lesson may include a user input, generated response, and the corresponding user feedback. The feedback lesson generation module 202 may identify a set of features based on the user input associated with the user feedback. The features may refer to specific aspects of the user’s input that help the agent understand the intent, tone, and context. These features are used to determine why a particular response might need adjustment based on feedback. In some embodiments, the features may include, intent, entities, tone and sentiment, question type, conversation history, and the like. The feature of “intent” may refer to the purpose of goal behind the user input, and the feature of “intent” may correspond to values such as, “information request,” “command,” “clarification,” etc. The feedback lesson generation module 202 may identify a value of the feature of “intent” for a user input. For example, the user input is “how to install XYZ program in my computer?” The feedback lesson generation module 202 may determine the corresponding feature of “intent” is “information request.” In another example, the user input may be “book a flight for me,” and the feedback lesson generation module 202 may determine the corresponding feature of “intent” is “command.” The feature of “entities” may be determined based on specific information within the user input, such as names, dates, location, products, etc. The feature of “tone and sentiment” may be used to reflect the user’s emotional state or attitude, which may be correlated with the user feedback and help the agent adjust its response accordingly (e.g., being more empathetic in a negative situation). The feedback lesson generation module 202 may apply a machine learning model to the user input to identify a set of features and use the set of features to label and/or categorize the corresponding feedback lesson.

The feedback lesson generation module 202 may analyze the generated response associated with the user feedback to identify a set of features of the generated response. The features of the generated response may specify how the response is generated for the corresponding user input, and/or identify the specific aspect of the response that may have contributed to the user feedback, e.g., satisfaction or dissatisfaction. In some embodiments, the feedback lesson generation module 202 may use the features of the generated response for predicting whether the response will receive a positive or negative user feedback and for making targeted improvements in future interactions. The features of the generated response may include, “wording,” “tone,” “content,” and the like. The feedback lesson generation module 202 may apply a machine learning model to the generated response to identify a set of features of the generated response. For example, the feedback lesson generation module 202 may determine the feature of “tone” of the generate response to be formal, casual, dismissive, empathetic, respectful, etc. In one instance, the generated response may be “I’m afraid I can’t help with that” or “Oops! I don’t know,” and the like.

The feedback lesson generation module 202 may analyze the user feedback in each feedback lesson and identify the recommendations on improving the generated response based on the user feedback. User feedback may range from positive comments to specific complaints or suggestions and may be captured in a way that clarifies why the user was satisfied or dissatisfied. In some implementations, the feedback lesson generation module 202 may correlate the recommendations in the user feedback with the identified features of the generate response. For instance, if the user feedback includes, “This didn’t help. I wanted steps to reset my password,” the feedback reveals that the response was perceived as unhelpful and lacking in detail. The feedback lesson generation module 202 may determine that this recommendation is related to the feature of “content” in the generated response. Such direct comments highlight specific areas for improvement, e.g., the need for more specific, process-oriented guidance to improve the feature of “content” in the generated response.

The feedback lesson generation module 202 integrates the user input, generated response and the user feedback into a cohesive context that forms a feedback lesson. The feedback lesson provides a contextualized example, enabling the agent to learn from real-world interactions systematically. The user feedback in each feedback lesson may include a recommendation or guideline that shapes how the agent (e.g., via using a machine learning model) frames its response. In some implementations, the user feedback may be an integrated recommendation based on a plurality of user feedback in a similar situation. For example, the user feedback in a feedback lesson may be “provide actionable, step-by-step advice to enhance productivity, and user supportive language to motive the user.” Alternatively, the user feedback in a feedback lesson may include at least a portion of original comments from a user, such as, “I need more detailed steps on how to install the program,” “The agent is just cold and indifferent,” and the like. In some implementations, the feedback lessons may be stored in a data store (e.g., data store 214) and may be retrieved for generating responses during future interactions. In some embodiments, each feedback lesson may be labeled and/or identified based on the set of features of the user input included in the feedback lesson. In some embodiments, each feedback lesson may be stored as key-value pairs or more complex context-retrieval systems. Each key is tied to specific set of user input features, while the value is the corresponding user feedback and suggested improvement. In some embodiments, each feedback lesson may be stored in a vector-based memory system where the user input, generated response and the corresponding user feedback are encoded into embeddings (numeric representations). When a new user input is processed, the declarative agent service 130 may perform a similarity search to identify if any past feedback lessons apply based on how closely the new user input matches the features associated with the feedback lesson.

In some embodiments, human operators may analyze the user feedback instances, identify the corresponding features, and generate a feedback lesson. In some embodiments, the feedback lesson generation module 202 may use a machine learning model (e.g., Generative AI 140) to identify features associated with the corresponding feedback lesson (e.g., features of user input, features of generated response, features related to recommendations/user feedback0. For example, the feedback lesson generation module 202 may apply a machine learning model to the user input and the machine learning model may output a set of features of the user input, and each feature may be associated with a confidence score. The confidence score may be used to indicate a likelihood that the user input includes the respective feature, the level of importance of the respective feature in generating a response, or any other criteria. The feedback lesson generation module 202 may train the model to recognize patterns/features/parameters in the feedback lesson. The model may be trained to analyze user input, generated response, and user feedback to determine to identify the features and the correlation among the features. The machine learning model may be a supervised machine learning model that is trained on a labeled dataset where each input (e.g., user input) is associated with a specific label (e.g., “intent” = “information request,” “entities” = “XYZ program,” “tone or sentiment” = “frustrated,” etc.). The model learns from these training examples to generalize and make predictions on new, unseen data.

To train the machine learning model with the training dataset, the feedback lesson generation module 202 may define an objective function, which guides the model in learning to identify features associated with the user feedback example and the correlations among the different features. In some implementations, a loss function may be used as the objective function. This loss function measures the difference between the model’s predicted probabilities and the actual labels, guiding the optimization of the model’s parameters. During the training process, the model may be applied to the training examples, and based on the measured loss, the model’s weights may be adjusted during training to reduce the loss function and improve the model’s predictions. The training process involves feeding the training data into the model, which iteratively updates its weights based on the feedback from the loss function. For neural networks, this training is often conducted over multiple epochs, with each epoch representing a complete pass through the training dataset. Once the model is trained, when receiving a new user feedback example which includes a user input, a generated response and the corresponding user feedback, the feedback lesson generation module 202 may apply the trained machine learning model to the user feedback example and output features associated with the user feedback example, e.g., features of the user input, features of the generated response, recommendations in the user feedback that correspond to the features of the user input and/or features of the generated response.

The feedback lesson identification module 204 receives a new user input and identifies a feedback lesson that is relevant to the new user input. In some embodiments, when the feedback lesson identification module 204 receives a new input from a user, it may perform a similarity search to find if any feedback lessons are relevant to the current interaction. In some implementations, the feedback lesson identification module 204 may analyze the features of the new input and comparing them to features from feedback lessons. If the feedback lesson identification module 204 identifies that the new input resembles a feedback lesson, it may apply the recommendations gained from the feedback lesson to improve its response to the current user.

In some implementations, the feedback lesson identification module 204 may apply the machine learning model to the new user input and identify a set of features associated with the new user input. The feedback lesson identification module 204 performs a similarity search by comparing the features of the new user input with features of the feedback lessons. In some implementations, the feedback lesson identification module 204 may use keyword-based matching, phrase matching and/or synonym mapping to determine the similarities. For example, the feedback lesson identification module 204 may identify overlapping terms between the features of the new input and features of the feedback lesson. For instance, if a user input includes “password reset,” the feedback lesson identification module 204 may look for feedback lessons containing the same phrase and consider those lessons as potentially relevant. In some embodiments, the feedback lesson identification module 204 may apply contextual matching, such as vector-based embedding models that transform text inputs into numerical vectors and capture the underlying meaning in a high-dimensional space where similar concepts are located close to each other. These models, often created with machine learning algorithms like Word2Vec, GloVe, or BERT, may be used to detect similar meanings even when the language differs. For instance, “trouble logging in” and “can’t access my account” would produce vectors that are close in space, signaling to the feedback lesson identification module 204 that the two queries are similar.

In some implementations, the feedback lesson identification module 204 may identify a list of candidate feedback lessons, each feedback lesson is associated with a confidence score indicating the level of similarity between the respective feedback lesson and the new user input. In one example, when the feedback lesson identification module 204 identifies a potential match between a new input and a feedback lesson, the feedback lesson identification module 204 uses the confidence score to quantify the level of relevance, e.g., on a scale from 0 to 1. The feedback lesson identification module 204 may use the confidence score to determine/select which feedback lesson is applicable to the current user input and provides a structured way to prioritize responses based on their likelihood of relevance/similarity. In another example, the feedback lesson identification module 204 may set a confidence threshold—only feedback lessons that exceed this threshold will be considered good matches. For example, a score of 0.7 or higher may be required. If no matches meet the threshold, the feedback lesson identification module 204 may prompt the user for clarification or route the user input to a human agent to ensure accuracy. In another example, when multiple candidate feedback lessons have comparable high confidence scores, the feedback lesson identification module 204 may rank the candidate feedback lessons based on the confidence score, with the highest-scoring feedback lesson given priority.

The response generation module 206 uses the identified feedback lesson to generate response to the new user input. In some implementations, the response generation module 206 may use the identified feedback lesson to generate a prompt for input to a large language model (LLM). The generated prompt may include at least the user input, the identified feedback lesson, and a request to generate a response to the user input using the recommendation in the identified feedback lesson.

In some implementations, the generated prompt may integrate the recommendation in the identified feedback lesson with the user input. For example, a new user input may include “Why hasn’t my package arrived? It’s been delayed and I haven’t heard anything.” The feedback lesson identification module 204 may identify a feedback lesson that matches to the new user input, and the recommendation in the feedback lesson includes “Acknowledge the user’s frustration politely and empathetically. Ask for additional information, such as the order number, to help locate the order. Offer to check the current status of the order. If the user appears very frustrated, offer to escalate the issue if needed.” The response generation module 206 may generate a prompt to the LLM to generate a response. The prompt may include a request, such as, “Generate a response to the user query above by following the guidance from the feedback lesson. The response should be empathetic, polite, and address the delay. Additionally, politely request any necessary information to check the status and reassure the user that their concern is a priority.”

In some implementations, the response generation module 206 may directly use the identified feedback lesson as a context for generating the response to the user input. For example, instead of rephrasing or reformatting, the response generation module 206 may directly combine the user input and feedback lesson into a single contextual prompt for the LLM. In one example, the declarative agent service 130 may provide an inbox that receives a user input from a user. The response generation module 206 may automatically populate the inbox with the identified feedback lesson that matches the user input. The response generation module 206 may combine the user input and identified feedback lesson together as an input/prompt to the LLM to generate a response. For instance, a user may input “where is my order?” in the inbox, and the feedback lesson identification module 204 identifies a feedback lesson. The feedback lesson includes a user input “Can you tell me why my order hasn’t arrived yet?” a generated response “Your order is delayed due to high demand. We apologize for the inconvenience,” and a corresponding user feedback “That doesn’t tell me where my order is or when it will arrive. I’d like more specific information.” The response generation module 206 may generate a prompt to the LLM, e.g., “User input: “Where’s my package?” Identified feedback lesson: “….” Please identify the recommendation in the identified feedback lesson and use it to generate a response to the user input.” The response generation module 206 provides the prompt to the LLM to generate the requested response and receives an output from the LLM as a response to the user input.

The model training module 212 may apply an iterative process to train a machine-learning model whereby the model training module 212 updates parameter values of machine-learning models based on each of the set of training examples. The training examples may be processed together, individually, or in batches. To train a machine-learning model based on a training example, the model training module 212 applies the machine-learning model to the input data in the training example to generate an output based on a current set of parameter values. The model training module 212 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross-entropy loss function. The model training module 212 updates the set of parameters for the machine-learning model based on the score generated by the loss function. For example, the model training module 212 may apply gradient descent to update the set of parameters.

The data store 214 stores data used by the declarative agent service 130. For example, the data store 214 stores the feedback lessons. The data store 214 also stores trained machine-learning models trained by the model training module 212. For example, the data store 214 may store the set of parameters for a trained machine-learning model on one or more non-transitory, computer-readable media. The data store 214 uses computer-readable media to store data and may use databases to organize the stored data.

### GENERATING RESPONSE WITH FEEDBACK LESSON

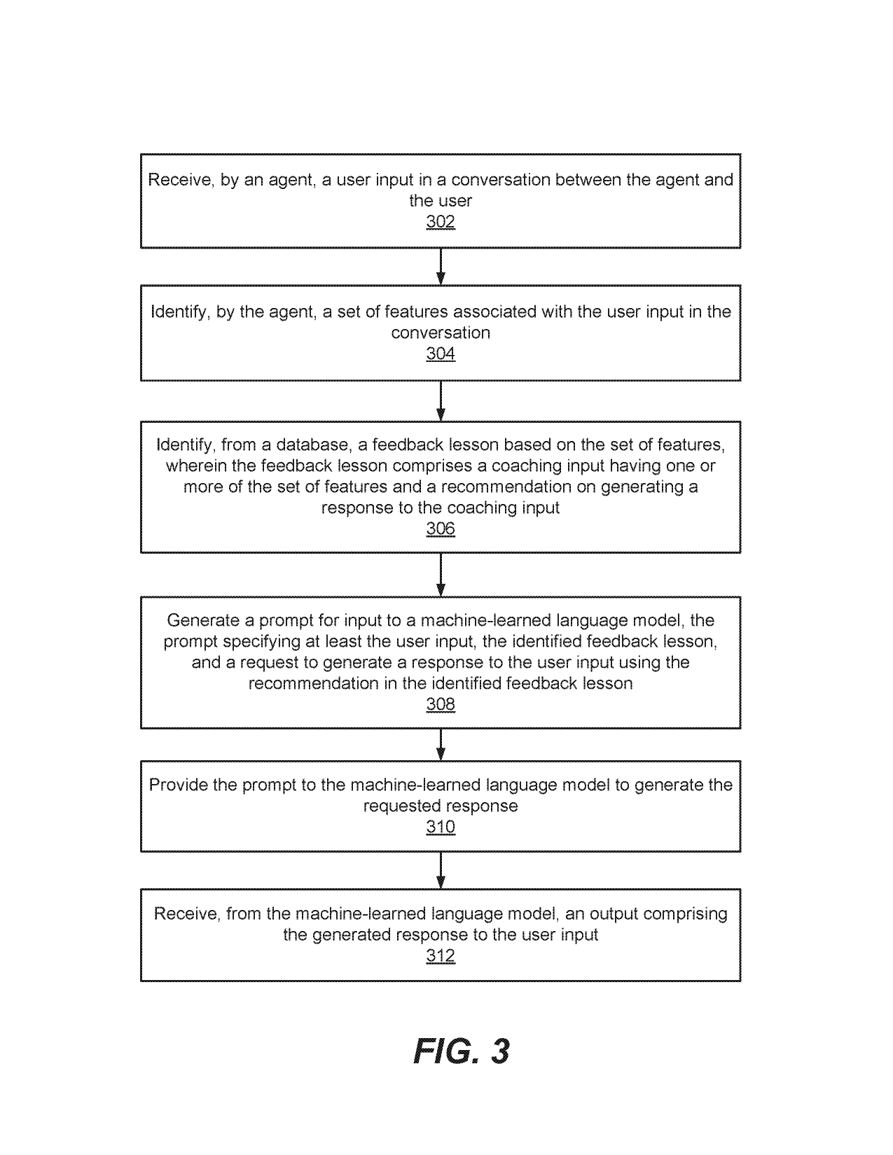

FIG. 3 is a flowchart for a method of generating a response to user input using a feedback lesson. Alternative embodiments may include more, fewer, or different steps from those illustrated in FIG. 3, and the steps may be performed in a different order from that illustrated in FIG. 3. These steps may be performed by a declarative agent service 130. Additionally, each of these steps may be performed automatically by the declarative agent service 130 without human intervention.

The declarative agent service 130 receives 302 a user input in a conversation between the agent and the user. The declarative agent service 130 may identify 304 a set of features associated with the user input in the conversation. The features may include “intent,” “entities,” “tone and sentiment,” etc., which may be used to identify and categorize the user input. For example, in some embodiments, the set of features may include one or more of intent, entities, tone, sentiment, question type, and conversation history. In some embodiments, the declarative agent service 130 identifies the set of features associated with the user input in the conversation by applying a machine learning model to the user input to identify the set of features.

Based the set of features, the declarative agent service 130 may identify 306 a feedback lesson. The feedback lesson may include at least a coaching input and user feedback. The coaching input may be a previous user input, and/or an input generated based on a plurality of user inputs in a similar situation. The coaching input may include one or more features that are similar to the set of features of the user input. The user feedback may include a recommendation on generating a response to the coaching input. In some embodiments, the feedback lesson may include the user input, a generated response by the agent, and a feedback instance. In some embodiments, the declarative agent service 130 generates an integrated recommendation for the feedback lesson based on a set of user feedback associated with situations within a threshold level of similarity to a situation described by the feedback lesson. The feedback lessons may be stored in a database, where each of the feedback lessons stored in the database is labeled with a set of features associated with a user input of the respective feedback lesson. In some embodiments, each feedback lesson is stored in the database as a key-value pair, where the key is associated with a set of features of a respective user input and the value corresponds to user feedback and a suggested improvement.

The declarative agent service 130 may generate 308 a prompt for input to a machine-learned language model. The prompt may specify at least the user input, the identified feedback lesson, and a request to generate a response to the user input using the recommendation in the identified feedback lesson. The declarative agent service 130 may provide 310 the prompt to the machine-learned language model to generate the requested response and receive 312 an output as the response to the user input.

In some embodiments, the declarative agent service 130 performs a similarity search on feedback lessons in the database in response to receiving the user input. The declarative agent service 130 identifies a list of candidate feedback lessons, where each candidate feedback lesson is associated with a confidence score indicating a level of similarity between the respective feedback lesson and the user input. The declarative agent service 130 selects one or more feedback lessons from the list of candidate feedback lessons based on the confidence score of the respective feedback lesson exceeding a confidence threshold. In some embodiments, in response to determining that none of the candidate feedback lessons are associated with a confidence score that meets the confidence threshold, the declarative agent service 130 prompts, via the agent, a user to provide clarification related to the user input. In some embodiments, in response to the confidence scores of the candidate feedback lessons being within a threshold range, the declarative agent service 130 ranks the candidate feedback lessons of the list based on confidence scores and selects a highest ranked candidate feedback lesson.

### COMPUTING MACHINE ARCHITECTURE

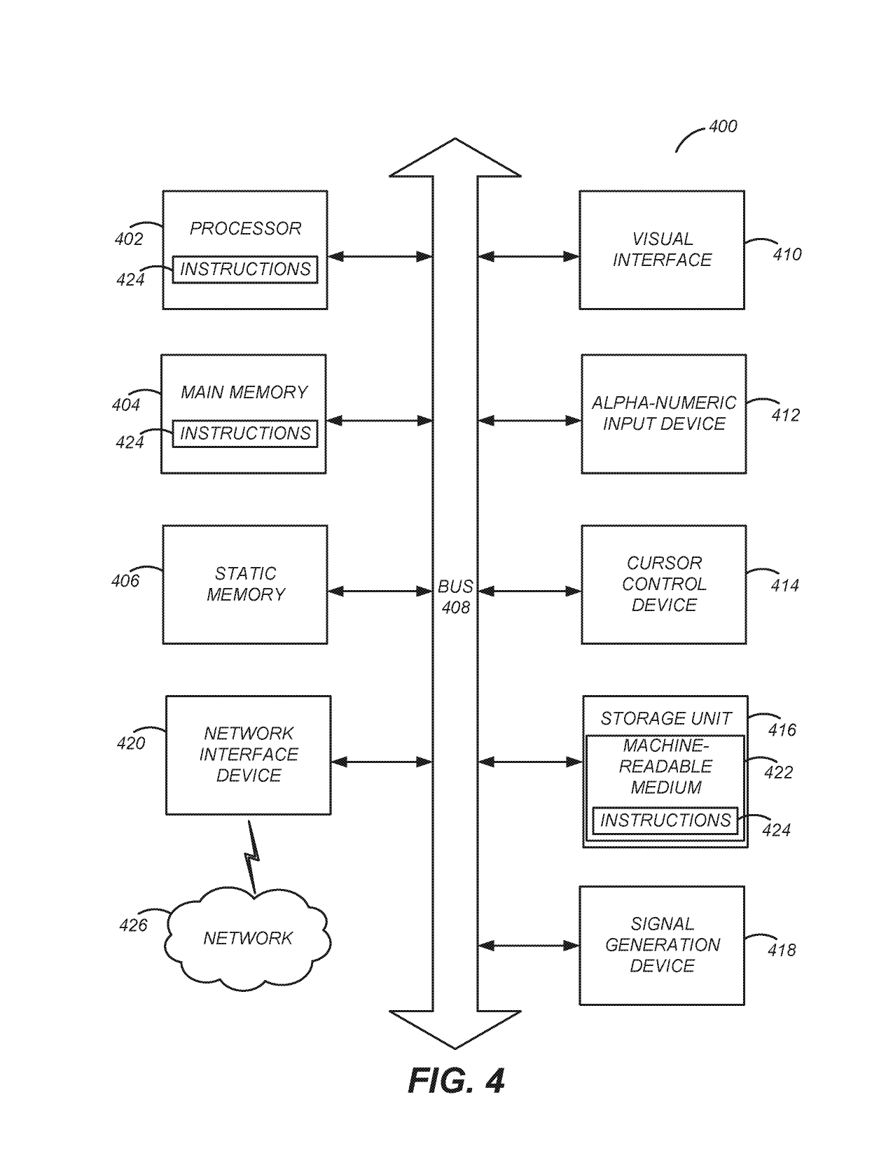

FIG. 4 is a block diagram illustrating components of an example machine able to read instructions from a machine-readable medium and execute them in a processor (or controller). Specifically, FIG. 4 shows a diagrammatic representation of a machine in the example form of a computer system 400 within which program code (e.g., software) for causing the machine to perform any one or more of the methodologies discussed herein may be executed. The program code may be comprised of instructions 424 executable by one or more processors 402. In alternative embodiments, the machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The machine may be a server computer, a client computer, a personal computer (PC), a tablet PC, a set-top box (STB), a personal digital assistant (PDA), a cellular telephone, a smartphone, a web appliance, a network router, switch or bridge, or any machine capable of executing instructions 424 (sequential or otherwise) that specify actions to be taken by that machine. Further, while only a single machine is illustrated, the term “machine” shall also be taken to include any collection of machines that individually or jointly execute instructions 124 to perform any one or more of the methodologies discussed herein.

The example computer system 400 includes a processor 402 (e.g., a central processing unit (CPU), a graphics processing unit (GPU), a digital signal processor (DSP), one or more application specific integrated circuits (ASICs), one or more radio-frequency integrated circuits (RFICs), or any combination of these), a main memory 404, and a static memory 406, which are configured to communicate with each other via a bus 408. The computer system 400 may further include visual display interface 410. The visual interface may include a software driver that enables displaying user interfaces on a screen (or display). The visual interface may display user interfaces directly (e.g., on the screen) or indirectly on a surface, window, or the like (e.g., via a visual projection unit). For ease of discussion the visual interface may be described as a screen. The visual interface 410 may include or may interface with a touch enabled screen. The computer system 400 may also include alphanumeric input device 412 (e.g., a keyboard or touch screen keyboard), a cursor control device 414 (e.g., a mouse, a trackball, a joystick, a motion sensor, or other pointing instrument), a storage unit 416, a signal generation device 418 (e.g., a speaker), and a network interface device 420, which also are configured to communicate via the bus 408.

The storage unit 416 includes a machine-readable medium 422 on which is stored instructions 424 (e.g., software) embodying any one or more of the methodologies or functions described herein. The instructions 424 (e.g., software) may also reside, completely or at least partially, within the main memory 404 or within the processor 402 (e.g., within a processor’s cache memory) during execution thereof by the computer system 400, the main memory 404 and the processor 402 also constituting machine-readable media. The instructions 424 (e.g., software) may be transmitted or received over a network 426 via the network interface device 420.

While machine-readable medium 422 is shown in an example embodiment to be a single medium, the term “machine-readable medium” should be taken to include a single medium or multiple media (e.g., a centralized or distributed database, or associated caches and servers) able to store instructions (e.g., instructions 424). The term “machine-readable medium” shall also be taken to include any medium that is capable of storing instructions (e.g., instructions 424) for execution by the machine and that cause the machine to perform any one or more of the methodologies disclosed herein. The term “machine-readable medium” includes, but not be limited to, data repositories in the form of solid-state memories, optical media, and magnetic media.

### ADDITIONAL CONFIGURATION CONSIDERATIONS

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Certain embodiments are described herein as including logic or a number of components, modules, or mechanisms. Modules may constitute either software modules (e.g., code embodied on a machine-readable medium or in a transmission signal) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the expression “coupled” and “connected” along with their derivatives. It should be understood that these terms are not intended as synonyms for each other. For example, some embodiments may be described using the term “connected” to indicate that two or more elements are in direct physical or electrical contact with each other. In another example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for a system and a process for reconciling configuration settings for imported resources through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A method comprising:
receiving, by an agent, a user input in a conversation between the agent and the user;
identifying, by the agent, a set of features associated with the user input in the conversation;
identifying, from a database, a feedback lesson based on the set of features, wherein the feedback lesson comprises a coaching input having one or more of the set of features and a recommendation on generating a response to the coaching input;
generating a prompt for input to a machine-learned language model, the prompt specifying at least the user input, the identified feedback lesson, and a request to generate a response to the user input using the recommendation in the identified feedback lesson;
providing the prompt to the machine-learned language model to generate the requested response; and
receiving, from the machine-learned language model, an output comprising the generated response to the user input.

2. The method of claim 1, wherein a feedback lesson includes a user input, a generated response by the agent, and a feedback instance.

3. The method of claim 1, wherein the set of features include one or more of intent, entities, tone, sentiment, question type, and conversation history.

4. The method of claim 1 wherein identifying, by the agent, the set of features associated with the user input in the conversation comprises:
applying a machine learning model to the user input to identify the set of features.

5. The method of claim 1, wherein the feedback lesson includes user feedback, the method further comprising:
generating an integrated recommendation for the feedback lesson based on a set of user feedback associated with situations within a threshold level of similarity to a situation described by the feedback lesson.

6. The method of claim 1, wherein the database includes a plurality of feedback lessons, each of the plurality of feedback lessons labeled with a set of features associated with a user input of the respective feedback lesson.

7. The method of claim 6, wherein each feedback lesson is stored in the database as a key-value pair, the key associated with a set of features of a respective user input and the value corresponding to user feedback and a suggested improvement.

8. The method of claim 6, further comprising:
in response to receiving the user input, performing a similarity search on feedback lessons in the database;
identifying a list of candidate feedback lessons, each associated with a confidence score indicating a level of similarity between the respective feedback lesson and the user input; and
selecting one or more feedback lessons from the list of candidate feedback lessons based on the confidence score of the respective feedback lesson exceeding a confidence threshold.

9. The method of claim 8, the method further comprising:
in response to determining that none of the candidate feedback lessons are associated with a confidence score that meets the confidence threshold, prompting, via the agent, a user to provide clarification related to the user input.

10. The method of claim 8, the method further comprising:
in response to the confidence scores of the candidate feedback lessons being within a threshold range, ranking the candidate feedback lessons of the list based on confidence scores; and
selecting a highest ranked candidate feedback lesson.

11. A non-transitory computer-readable storage medium storing instructions that, when executed, cause a processor to perform steps comprising:
receiving, by an agent, a user input in a conversation between the agent and the user;
identifying, by the agent, a set of features associated with the user input in the conversation;
identifying, from a database, a feedback lesson based on the set of features, wherein the feedback lesson comprises a coaching input having one or more of the set of features and a recommendation on generating a response to the coaching input;
generating a prompt for input to a machine-learned language model, the prompt specifying at least the user input, the identified feedback lesson, and a request to generate a response to the user input using the recommendation in the identified feedback lesson;
providing the prompt to the machine-learned language model to generate the requested response; and
receiving, from the machine-learned language model, an output comprising the generated response to the user input.

12. The non-transitory computer-readable storage medium of claim 11, wherein a feedback lesson includes a user input, a generated response by the agent, and a feedback instance.

13. The non-transitory computer-readable storage medium of claim 11, wherein the set of features include one or more of intent, entities, tone, sentiment, question type, and conversation history.

14. The non-transitory computer-readable storage medium of claim 11 wherein identifying, by the agent, the set of features associated with the user input in the conversation comprises:
applying a machine learning model to the user input to identify the set of features.

15. The non-transitory computer-readable storage medium of claim 11, wherein the feedback lesson includes user feedback, the steps further comprising:
generating an integrated recommendation for the feedback lesson based on a set of user feedback associated with situations within a threshold level of similarity to a situation described by the feedback lesson.

16. The non-transitory computer-readable storage medium of claim 11, wherein the database includes a plurality of feedback lessons, each of the plurality of feedback lessons labeled with a set of features associated with a user input of the respective feedback lesson.

17. The non-transitory computer-readable storage medium of claim 16, wherein each feedback lesson is stored in the database as a key-value pair, the key associated with a set of features of a respective user input and the value corresponding to user feedback and a suggested improvement.

18. The non-transitory computer-readable storage medium of claim 16, the steps further comprising:
in response to receiving the user input, performing a similarity search on feedback lessons in the database;
identifying a list of candidate feedback lessons, each associated with a confidence score indicating a level of similarity between the respective feedback lesson and the user input; and
selecting one or more feedback lessons from the list of candidate feedback lessons based on the confidence score of the respective feedback lesson exceeding a confidence threshold.

19. The non-transitory computer-readable storage medium of claim 18, the steps further comprising:
in response to determining that none of the candidate feedback lessons are associated with a confidence score that meets the confidence threshold, prompting, via the agent, a user to provide clarification related to the user input.

20. A system comprising:
a processor; and
a non-transitory computer-readable storage medium storing instructions that, when executed, cause the processor to perform steps comprising:
receiving, by an agent, a user input in a conversation between the agent and the user;
identifying, by the agent, a set of features associated with the user input in the conversation;
identifying, from a database, a feedback lesson based on the set of features, wherein the feedback lesson comprises a coaching input having one or more of the set of features and a recommendation on generating a response to the coaching input;
generating a prompt for input to a machine-learned language model, the prompt specifying at least the user input, the identified feedback lesson, and a request to generate a response to the user input using the recommendation in the identified feedback lesson;
providing the prompt to the machine-learned language model to generate the requested response; and
receiving, from the machine-learned language model, an output comprising the generated response to the user input.
